(19) United States
(12) Patent Application Publication
(10) Pub. No.: US 2007/0135987 A1
(43) Pub. Date: Jun. 14, 2007

(54) System and method for turbine engine igniter lifing

(75) Inventors: Scot J. Coffey, Mesa, AZ (US); Kevin A. Jones, Laveen, AZ (US); Michael D. James, Phoenix, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International

(21) Appl. No.: 11/285,812

(22) Filed: Nov. 22, 2005

(51) Int. Cl. G01M 19/02; F02P 17/02; G01N 3/56

(52) U.S. Cl. 701/100; 702/35; 73/7; 73/118.1

(57) ABSTRACT

An igniter lifing system and method is provided that facilitates improved igniter plug wear and remaining life prediction. The igniter lifing system and method uses operating conditions measured during ignition to estimate how much wear has occurred on an igniter. Specifically, the igniter lifing system and method uses ignition time and pressure data to predict wear on the igniter plug and make an estimate of the remaining life. In one embodiment, the igniter lifing system calculates the incremental igniter wear for each use of the igniter as a function of the turbine combustor pressure during that use. Then, by summing the incremental igniter wear calculations, the accumulated igniter wear can be calculated, and an estimate of the remaining igniter life can be determined.

### FIELD OF THE INVENTION

This invention generally relates to diagnostic systems, and more specifically relates to component lifing in turbine engines.

### BACKGROUND OF THE INVENTION

Engines are a particularly critical part of modem aircraft, and the reliability of engines in the aircraft is thus of critical importance. One technique for improving the reliability of engines and other complex systems is to estimate the operational lifetime of critical components in the system and repair or replace those components before those components have an unacceptable probability of failure.

The process of estimating the operational lifetime of a component is generally referred to as component lifing. The techniques used for component lifing generally must be specifically tailored to the component, the operational conditions of the component, and the most common failure modes for the component.

One critical system in turbine engines is the ignition system. In general, the ignition system provides spark to the combustion chamber to initiate or maintain combustion. The ignition system is typically used during engine startup, but can also be used in other situations, such as for stall protection in situations where lean blowout is a possibility.

A typical ignition system includes an exciter that generates the high voltage needed, one or more ignition leads and one or more igniter plugs. The igniter plugs are located in the combustion chamber where they can provide the needed spark to the combustion chamber for engine startup and other situations. The igniter plugs are subject to wear during use and must be periodically replaced to maintain high ignition system reliability. This wear typically takes the form of erosion of the electrodes on the igniter. Eventually, the erosion can cause the gap between electrodes to become larger, which can negatively impact the reliability of the igniter plug and may eventually make the igniter plug inoperable.

Thus, it is desirable to be able to accurately predict igniter wear to provide an accurate determination of when an igniter should be replaced. Unfortunately, previous methods of predicting the operational lifetime of igniters have had limited accuracy. Inaccuracy in the lifing calculation can cause the igniter to be repaired or replaced well before the lifetime of the component is actually used up. Alternatively, inaccuracy in igniter lifing can allow the component to fail before it is replaced. In either case, the inaccuracy in component lifing is highly undesirable.

### BRIEF SUMMARY OF THE INVENTION

The present invention provides a turbine engine igniter lifing system and method that facilitates improved igniter plug wear and remaining life prediction. The igniter lifing system and method uses operating conditions measured during ignition to estimate how much wear has occurred on an igniter. Specifically, the igniter lifing system and method uses ignition time and pressure data to predict wear on the igniter plug and make an estimate of the remaining life

The igniter lifing system receives operational time and pressure data from the turbine engine and calculates the resulting wear and remaining life on the igniter plug. In one embodiment, the igniter lifing system calculates the incremental igniter wear for each use of the igniter as a function of the turbine combustor pressure during that use. Then, by summing the incremental igniter were calculations, the accumulated igniter wear can be calculated, and an estimate of the remaining igniter life can be determined.

### BRIEF DESCRIPTION OF DRAWINGS

The preferred exemplary embodiment of the present invention will hereinafter be described in conjunction with the appended drawings, where like designations denote like elements, and:

FIG. 1 is a schematic view of an igniter lifing system in accordance with an embodiment of the invention;

FIG. 2 is a schematic view an exemplary turbine engine in accordance with an embodiment of the invention;

FIG. 3 is a graphical view illustrating an exemplary relationship between igniter time of use, pressure, and igniter plug wear;

FIG. 4 is a flow diagram of a igniter plug lifing calculation method in accordance with an embodiment of the invention; and

FIG. 5 is a schematic view of a computer system that includes an igniter lifing program.

### DETAILED DESCRIPTION OF THE INVENTION

The present invention provides a turbine engine igniter lifing system and method that facilitates improved igniter plug wear and remaining life prediction. The igniter lifing system and method uses operating conditions measured during ignition to estimate how much wear has occurred on an igniter. Specifically, the igniter lifing system and method uses ignition time and pressure data to predict wear on the igniter plug and make an estimate of the remaining life.

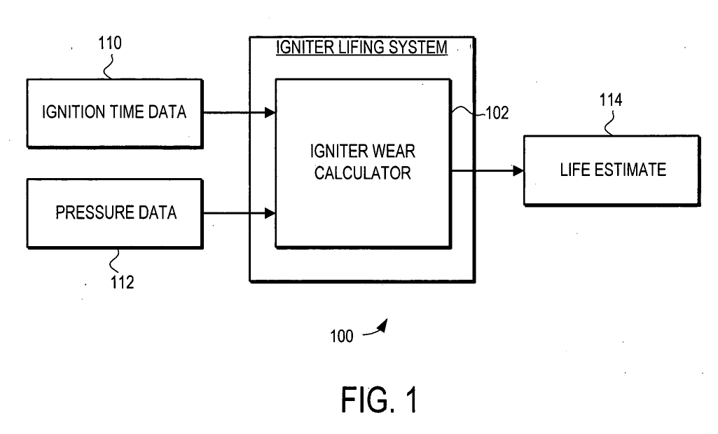

Turning now to FIG. 1, a schematic view of an igniter lifing system 100 is illustrated. The lifing system 100 includes an igniter wear calculator 102 and receives ignition time data 110 and pressure data 112 from the turbine engine. The igniter wear calculator 102 uses the ignition time data 110 and pressure data 112 to calculate the resulting wear on the igniter plug. From this wear calculation, a remaining life estimate 114 of the igniter plug can be generated. In one embodiment, the igniter lifing calculator 102 calculates the incremental igniter wear for each use of the igniter plug as a function of the turbine combustor pressure during that use. Then, by summing the incremental igniter wear calculations, the accumulated igniter wear can be calculated, and an estimate of the remaining igniter life can be determined.

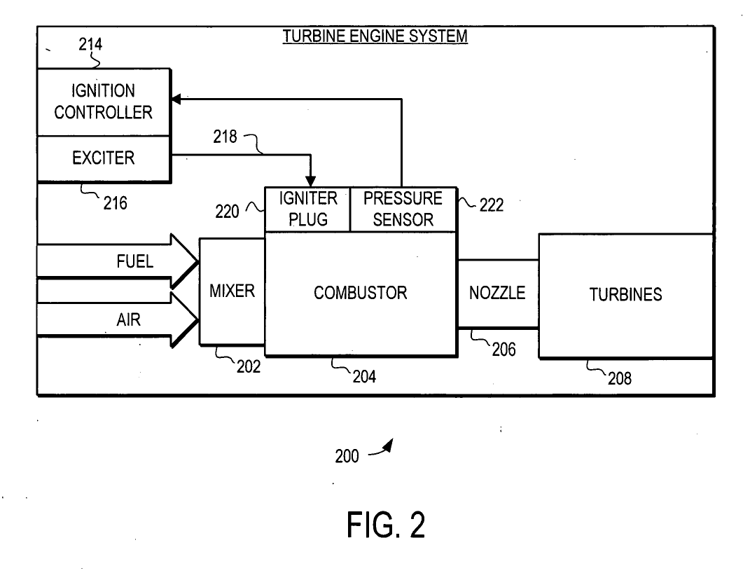

Turning now to FIG. 2, a schematic view of a turbine engine system 200 is illustrated. The turbine engine system 200 is illustrated broadly and is meant to represent the general features of turbine engines. The turbine engine system 200 includes a fuel and air mixer 202, a combustor 204, a nozzle 206 turbines 208. Again, this is a very simplified example of a typical turbine engine. During operation of the turbine engine, fuel and air is provided to the mixer 202, where the fuel is mixed with air and delivered to the combustor 204. The fuel/air mixture is ignited inside the combustor 204, causing an increase in temperature of the gases delivered to the turbines 208 through nozzle 206. This causes the turbines to rotate, thus generating power that can be used for a variety of purposes. For example, the power can be used for propulsion, such as aircraft or other vehicle propulsion, or it can be used for power generation, such as in an auxiliary power unit (APU).

It should be noted that not all turbine engines include all the features illustrated in FIG. 2. For example, some turbine engines may not include mixer 202. The embodiments of the invention could be applied to any type of turbine engine for any application, whether or not it includes all the features illustrated in FIG. 2.

Also included in this embodiment of the turbine engine system 200 is an ignition controller 214, an exciter 216, igniter leads 218, an igniter plug 220 and a pressure sensor 222. The ignition controller 214, exciter 216, ignition leads 218 and igniter plug 220 are part of the ignition system for the turbine engine. In general, the ignition system provides spark to the combustor 204 chamber to initiate or maintain combustion. The ignition system is typically used during engine startup, but can also be used in other situations, such as for stall protection in situations where lean blowout is a possibility. The ignition controller 214 controls the operation of the ignition system, and can be implemented with a variety of different devices, such as ECUs and other programmable devices. The exciter 216 generates the high voltage needed for proper ignition, which when directed by the ignition controller 214 is delivered to the igniter plug 220 via ignition leads 218. Again, this is simplified representation of a typical ignition system. For example, most ignition systems include multiple exciters, leads and igniter plugs for redundancy. In accordance with one embodiment of the invention, the pressure sensor 222 measures pressure in the combustor 204 and delivers the pressure data back to the ignition controller, where it is combined with ignition time data and used for igniter plug wear prediction and lifing.

As stated above, the ignition system is typically used during engine startup, but can also be used in other situations, such as for stall protection in situations where lean blowout is a possibility. During engine startup, the combustor pressure is typically relatively low. However, when used for stall protection during turbine engine operation, the combustor pressure can be much higher. During operation of the ignition system, the wear of the electrodes that occurs during each ignition event is dependent upon the pressure around the igniter plug, typically the combustor pressure sometimes referred to as P3. Thus, in one embodiment the igniter lifing system and method uses the pressure and time from each ignition event to calculate the incremental wear that has occurred during that ignition event.

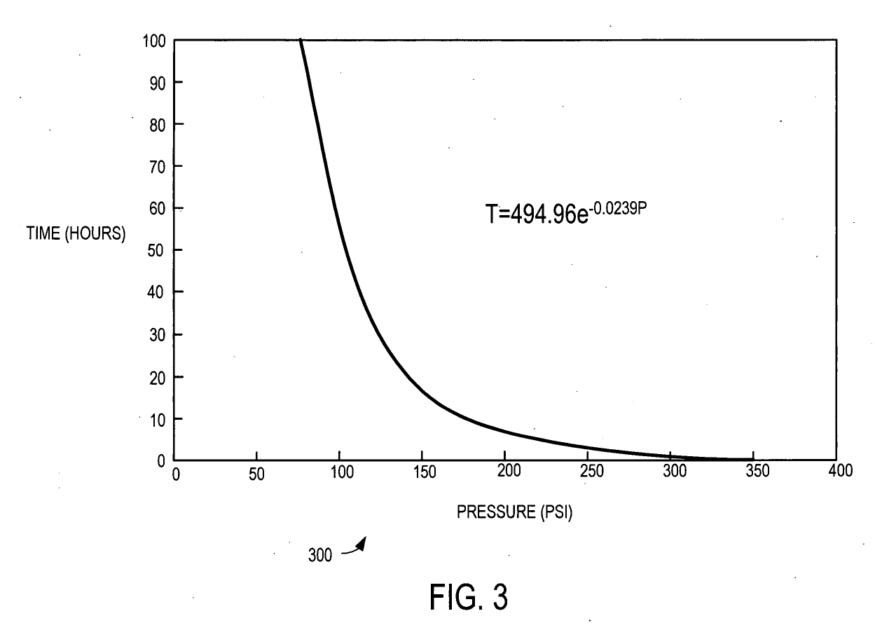

Turning now to FIG. 3, a graph 300 illustrates an exemplary relationship between igniter time of use, pressure, and igniter plug wear. It should be noted that graph 300 is merely exemplary for one type of igniter plug in one type of turbine engine, and that other igniter plugs in other in turbine engines would have different relationships. In FIG. 3, the relationship between igniter plug wear and time and pressure can be expressed as:
T=494.96e^{-0.0239P} (1)
where P is the pressure in PSI and T is the igniter lifetime in hours. Thus, at a pressure of 100 PSI the igniter plug will have an estimated lifetime of 45.54 hours, while at a pressure of 150 PSI the igniter plug will have an estimated lifetime of 13.73 hours. This relationship can thus be used to calculate the incremental percentage of wear that occurs for each ignition event.

For example, the incremental percentage of wear can be expressed as:

$$\% L = \frac{I}{494.96 {ⅇ}^{- 0.0239 P}} \qquad ( 1 )$$

where % L is the percentage of igniter lifetime used, I is the incremental time of in hours and P is the pressure in PSI. Thus, an ignition event that lasts one minute (0.0167 hours) at a pressure of 100 PSI will use 0.000366% of the operational lifetime of the igniter plug, while an ignition event that lasts 30 seconds (0.0083 hours) at 150 PSI will use 0.000607% of the operational lifetime. By calculating the incremental lifetime consumption for each ignition event, and accumulating the incremental lifetime consumed, the overall wear and remaining life of the igniter plug can thus be calculated.

This relationship can thus be used to calculate the incremental wear that occurs for each ignition event. In one embodiment, to simplify the wear calculation the relationship between pressure and wear is simplified by using an average wear that occurs over a given temperature range. For example, using equation 2 the average wear that occurs between 100 and 150 PSI can be calculated and used to calculate the wear that occurs for any ignition events that occur at a pressure within the range, and similar calculations made for other ranges. This simplifies the calculation of igniter plug wear, while providing acceptable accuracy for some applications. Furthermore, this procedure can simplify data collection, as instead of recording precise pressure values for each ignition event, the lifing system only needs to record which range of pressure existed for the ignition event.

In another variation on this embodiment, instead of using an average, the maximum rate of wear for a range of pressures can be used. For example, the rate of wear that occurs at 150 PSI can be calculated as used for pressures in the range of 100 to 150 PSI. This again simplifies calculation, and has the advantage of providing an additional margin of safety for the calculation. In either case, the resulting accumulated lifetime calculation can then be calculated as described above.

As one specific example, the average wear rate is calculated for pressure ranges between 0-180, 181-195, 196-210, 211-225, 226-235, 236-243, 244-248, 249-290, 291-310, 311-330 and 331-340 PSI. During operation of the turbine, the time of usage is recorded along with the corresponding pressure range for that use. Then, the incremental wear calculations are made and an estimate of the accumulated wear and remaining life is made.

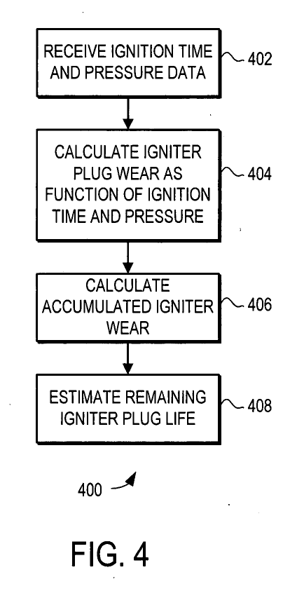

Turning now to FIG. 4, a flow diagram illustrates an exemplary method 400 of estimating remaining igniter plug life in accordance with an embodiment of the invention. The method 400 facilitates improved igniter plug wear and remaining life prediction by using operating conditions measured during ignition. Specifically, the method 400 uses ignition time and pressure data to predict wear on the igniter plug and make an estimate of the remaining life.

The first step 402 in method 400 is to receive ignition time and pressure data. In one embodiment, the ignition time and pressure data is stored by the ignition control system on the turbine engine. For example, in the ECU used for control of the exciter in the ignition system. The ignition control system can then use that data to estimate the remaining life of the igniter plugs itself, or the data can be passed to a separate diagnostic system for the igniter plug lifing calculation.

In general, the ignition time and pressure data comprises the amount of ignition time a plug has been used and the corresponding pressure during those ignition times. In some embodiments, the ignition time and pressure data is stored as the amount of ignition time at various pressure ranges. For example, that there has been 22 minutes of ignition time at a pressure range of between 100 and 150 PSI, and 30 minutes at a pressure range of between 150 and 200 PSI. In other embodiments the actual recorded pressure for each ignition event and the length of time of each ignition event is stored.

The next step 404 is to calculate igniter plug wear increments as a function of ignition time and pressure. The methods used for calculating the igniter plug wear would typically depend on the structure of the time and pressure data that is stored and used. In one embodiment, the igniter wear is calculating using the functional relationship between pressure and igniter wear, such as the relationship described in equations 1 and 2 above. In another embodiment, the igniter wear is calculated using an average wear that occurs over a given pressure range. In both cases, the igniter wear is calculated for each ignition event as a function of the corresponding pressure during that event.

The next step 406 is to calculate accumulated igniter wear from the igniter wear increments. In most cases this can be accomplished by summing the individual amounts of igniter plug wear to calculate the overall igniter wear. In variations on this embodiment, the individual wear increments are weighted to account of for other causes of igniter plug wear, such as where igniter plug wear increases with age.

The next step 408 is to estimate the remaining igniter plug life. This step can generally be performed by subtracting the amount of wear that has occurred from the overall lifespan of the igniter plug. Of course, other methods could also be used. Thus, method 400 facilitates improved igniter plug wear and remaining life prediction by using ignition time and pressure data to predict wear on the igniter plug and make an estimate of the remaining life.

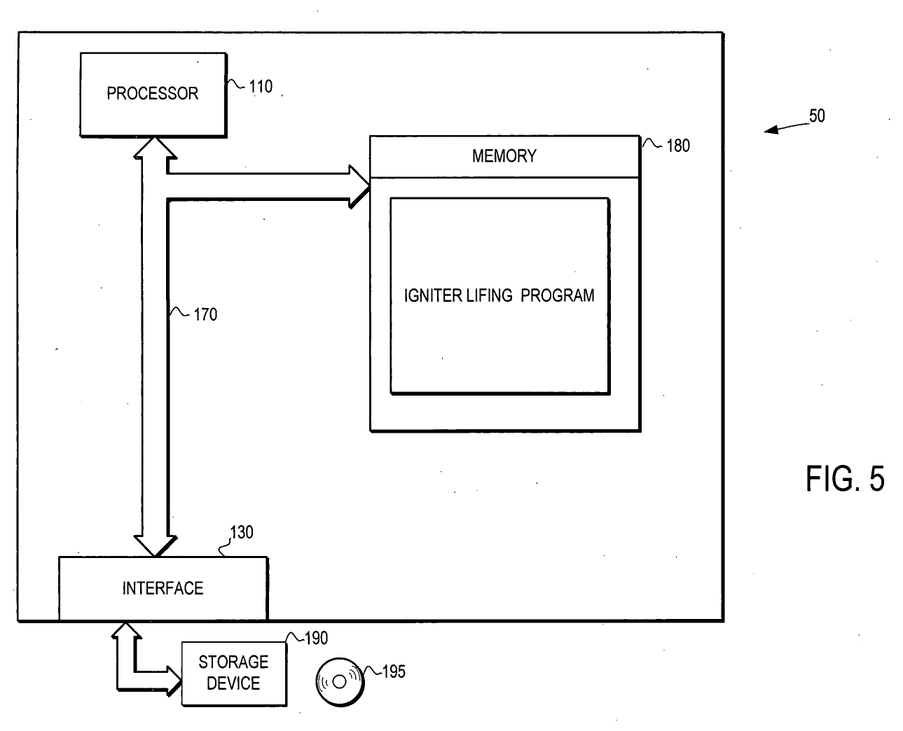

The igniter lifing system and method can be implemented in wide variety of platforms. Turning now to FIG. 5, an exemplary computer system 50 is illustrated. Computer system 50 illustrates the general features of a computer system that can be used to implement the invention. Of course, these features are merely exemplary, and it should be understood that the invention can be implemented using different types of hardware that can include more or different features. It should be noted that the computer system can be implemented in many different environments, such as onboard an aircraft to provide onboard diagnostics, or on the ground to provide remote diagnostics. The exemplary computer system 50 includes a processor 110, an interface 130, a storage device 190, a bus 170 and a memory 180. In accordance with the preferred embodiments of the invention, the memory system 50 includes an igniter component lifing program.

The processor 110 performs the computation and control functions of the system 50. The processor 1 10 may comprise any type of processor, including single integrated circuits such as a microprocessor, or may comprise any suitable number of integrated circuit devices and/or circuit boards working in cooperation to accomplish the functions of a processing unit. In addition, processor 110 may comprise multiple processors implemented on separate systems. In addition, the processor 110 may be part of an overall vehicle control, navigation, avionics, communication or diagnostic system. During operation, the processor 110 executes the programs contained within memory 180 and as such, controls the general operation of the computer system 50.

Memory 180 can be any type of suitable memory. This would include the various types of dynamic random access memory (DRAM) such as SDRAM, the various types of static RAM (SRAM), and the various types of non-volatile memory (PROM, EPROM, and flash). It should be understood that memory 180 may be a single type of memory component, or it may be composed of many different types of memory components. In addition, the memory 180 and the processor 110 may be distributed across several different computers that collectively comprise system 50. For example, a portion of memory 180 may reside on the vehicle system computer, and another portion may reside on a central based diagnostic computer.

The bus 170 serves to transmit programs, data, status and other information or signals between the various components of system 100. The bus 170 can be any suitable physical or logical means of connecting computer systems and components. This includes, but is not limited to, direct hard-wired connections, fiber optics, infrared and wireless bus technologies.

The interface 130 allows communication to the system 50, and can be implemented using any suitable method and apparatus. It can include a network interfaces to communicate to other systems, terminal interfaces to communicate with technicians, and storage interfaces to connect to storage apparatuses such as storage device 190. Storage device 190 can be any suitable type of storage apparatus, including direct access storage devices such as hard disk drives, flash systems, floppy disk drives and optical disk drives. As shown in FIG. 5, storage device 190 can comprise a disc drive device that uses discs 195 to store data.

In accordance with the preferred embodiments of the invention, the computer system 50 includes the igniter lifing program. Specifically during operation, the igniter lifing program is stored in memory 180 and executed by processor 110.

As one example implementation, the igniter lifing program can operate on data that is acquired from the turbine engine and periodically uploaded to an internet website. The lifing analysis is performed by the web site and the results are returned back to the technician or other user. Thus, the system can be implemented as part of a web-based diagnostic and prognostic system.

It should be understood that while the present invention is described here in the context of a fully functioning computer system, those skilled in the art will recognize that the mechanisms of the present invention are capable of being distributed as a program product in a variety of forms, and that the present invention applies equally regardless of the particular type of computer-readable signal bearing media used to carry out the distribution. Examples of signal bearing media include: recordable media such as floppy disks, hard drives, memory cards and optical disks (e.g., disk 195), and transmission media such as digital and analog communication links, including wireless communication links.

Thus, the embodiments of the present invention provide a turbine engine igniter lifing system and method that facilitates improved igniter plug wear and remaining life prediction. The igniter lifing system and method uses operating conditions measured during ignition to estimate how much wear has occurred on an igniter. Specifically, the igniter lifing system and method uses ignition time and pressure data to predict wear on the igniter plug and make an estimate of the remaining life. In one embodiment, the igniter lifing system calculates the incremental igniter wear for each use of the igniter as a function of the turbine combustor pressure during that use. Then, by summing the incremental igniter wear calculations, the accumulated igniter wear can be calculated, and an estimate of the remaining igniter life can be determined.

The embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed. Many modifications and variations are possible in light of the above teaching without departing from the spirit of the forthcoming claims.

1. A lifing system for estimating remaining life of an igniter plug in a turbine engine, the lifing system comprising:
an igniter wear calculator, the igniter wear calculator adapted to receive ignition time data and pressure data from the turbine engine, the igniter wear calculator adapted to calculate igniter wear as a function of the ignition time data and the pressure data.

2. The system of claim 1 wherein the pressure data comprises combustor pressure during ignition.

3. The system of claim 1 wherein the igniter wear calculator is adapted to calculate igniter wear based on a rate of wear for a corresponding pressure range.

4. The system of claim 1 wherein the igniter wear calculator is adapted to calculate igniter wear by calculating incremental igniter wear as a function of combustion pressure and summing the incremental igniter wear.

5. The system of claim 1 wherein the igniter wear calculator is adapted to calculate an incremental igniter wear for each ignition event as a function of a combustor pressure range during the ignition event, wherein the igniter wear calculator is adapted to sum the incremental igniter wear for each ignition event to calculate igniter wear.

6. The system of claim 1 wherein the pressure data comprises combustor pressure during each ignition event, and wherein the igniter wear calculator includes an average rate of wear for each of a plurality of pressure ranges, and wherein the igniter wear calculator calculates incremental igniter wear for each ignition event based on the average rate of wear for a corresponding pressure range and the ignition time for each ignition event and wherein the igniter wear calculator sums the incremental igniter wear to generate an accumulated igniter wear.

7. A method of estimating remaining life in a turbine engine igniter plug, the method comprising the steps of:
receiving ignition time data and pressure data;
calculating incremental wear of the igniter plug as a function of the ignition time data and the pressure data; and
calculating accumulated igniter plug wear from the incremental wear.

8. The method of claim 7 wherein the pressure data comprises combustor pressure during ignition.

9. The method of claim 7 further comprising the step of estimating remaining igniter plug life from the accumulated igniter plug wear.

10. The method of claim 7 wherein the step of calculating incremental wear of the igniter plug as a function of the ignition time data and the pressure data comprises calculating igniter wear based on a rate of wear for a corresponding pressure range.

11. The method of claim 7 wherein the step of calculating incremental wear of the igniter plug as a function of the ignition time data and the pressure data comprises calculating igniter wear by calculating incremental igniter wear as a function of a combustion pressure range during an ignition event and wherein the step of calculating accumulated igniter plug wear from the incremental wear comprises summing the incremental igniter wear.

12. The method of claim 7 wherein the step of calculating incremental wear of the igniter plug as a function of the ignition time data and the pressure data comprises calculating incremental igniter wear for each ignition event as a function of combustor pressure during the ignition event; and wherein the step of calculating accumulated igniter plug wear from the incremental wear comprises summing the incremental igniter wear to generate an accumulated igniter wear.

13. The method of claim 7 wherein the step of receiving ignition time data and pressure data comprises receiving combustor pressure data for each of a plurality of ignition events, and wherein the step of calculating incremental wear of the igniter plug as a function of the ignition time data and the pressure data comprises calculating incremental wear for each ignition event based on an average rate of wear for each of a plurality of pressure ranges and the ignition time for each ignition event, and wherein the step of calculating accumulated igniter plug wear from the incremental wear comprises summing the incremental igniter wear to generate an accumulated igniter wear.

14. A program product comprising:
a) an igniter lifing program for estimating remaining life of an igniter plug in a turbine engine, the program including:
an igniter wear calculator, the igniter wear calculator adapted to receive ignition time data and pressure data from the turbine engine, the igniter wear calculator adapted to calculate igniter wear as a function of the ignition time data and the pressure data; and
b) computer-readable signal bearing media bearing said program.

15. The program product of claim 14 wherein the pressure data comprises combustor pressure during ignition.

16. The program product of claim 14 wherein the igniter wear calculator is adapted to calculate igniter wear based on a rate of wear for a corresponding pressure range.

17. The program product of claim 14 wherein the igniter wear calculator is adapted to calculate igniter wear by calculating incremental igniter wear as a function of combustion pressure and summing the incremental igniter wear.

18. The program product of claim 14 wherein the igniter wear calculator is adapted to calculate an incremental igniter wear for each ignition event as a function of combustor pressure range during the ignition event, wherein the igniter wear calculator is adapted to sum the incremental igniter wear for each ignition event to calculate igniter wear.

19. The program product of claim 14 wherein the pressure data comprises combustor pressure during each ignition event, and wherein igniter wear calculator includes an average rate of wear for each of a plurality of pressure ranges, and wherein the igniter wear calculator calculates incremental igniter wear for each ignition event based on the average rate of wear for a corresponding pressure range and the ignition time for each ignition event and wherein the igniter wear calculator sums the incremental igniter wear to generate an accumulated igniter wear.
